(19) United States
(12) Patent Application Publication
(10) Pub. No.: US 2021/0159979 A1
(43) Pub. Date: May 27, 2021

(54) METHOD AND APPARATUS FOR OPTICAL COMMUNICATION

(71) Applicant: Eugene M. ODonnell, Fishers, IN (US)

(72) Inventor: Eugene M. ODonnell, Fishers, IN (US)

(21) Appl. No.: 17/102,288

(22) Filed: Nov. 23, 2020

Related U.S. Application Data
(60) Provisional application No. 62/939,933, filed on Nov. 25, 2019.

(51) Int. Cl. H04B 10/114; H04W 16/20; G06T 7/00

(52) U.S. Cl. CPC H04B 10/1143; H04W 16/20; G06T 2207/30242; G06T 2207/10004; G06T 7/0008

(57) ABSTRACT

A method and apparatus for microwave based thawing of food or other high water content products is described. The method includes adding ballast water to a container selected based on a volume of the item to be defrosted or thawed. The apparatus includes a container with markings to measure volume of an item and ballast water and may include positioning and temperature sensing features which may be used to efficiently thaw an item.

### BACKGROUND

### 1. Field of the Invention

The present invention is related to methods and systems for optical communication. In particular it relates to a system wherein a display of a device is modulated to send optical data to a camera of another device.

### 2. Description of the Related Art

There are various methods of performing optical communication between devices.

Various wavelengths and frequencies of optical radiation may be used to allow devices to communicate using photons. All of these systems require that there is a line of sight between a sending device, i.e. an emitter of optical energy, and a receiving device, i.e. a detector of optical energy. A system which uses the display of a device to emit a visible wavelength optical signal which can be detected by a camera at a distance has been previously described in publications such as U.S. patent Ser. No. 10/324,676, by Eugene M. O'Donnell. Such a system uses modulation of a display of a sending device to send an optical signal to a receiving device. Typically the sending device is a mobile device which comprises a display and a camera such as a mobile phone, tablet, etc. A receiving device comprises a camera, or other optical detector. In some instances, a receiving device may also be a mobile device such as a mobile phone or tablet device.

Such systems have found market acceptance as a means of locating a particular device precisely in a location which is defined by a software mapping of a physical space assigned to a receiving device. However, such a system may have some weaknesses. As such, a line of sight from a sending device to a receiving device is required. Any object which blocks the display of the sending device from being visible to the receiving device may interfere with an optical communication link. This may produce confusion for users as a user may not be aware of a location assigned to a receiving device and may be unable to determine what is causing a blocking of the line of sight. As a consequence, consumer confusion may be caused, and a bad user experience may result.

Due to these and other problems a method and apparatus for optical communication which can assist in obtaining a line of sight would be greatly appreciated.

### SUMMARY

A camera is incorporated in a transmitting device which is intending to send an optical communication. A camera of a transmitting device may be located on the same side of the transmitting device as an emitter of optical energy which is to be used to communicate with a receiving device. A target device, which may be an emitter of optical energy or a reflective element is attached to a receiving device. A camera of the transmitting device may have a smaller field of view than a camera of a receiving device. A camera of a transmitting device is activated and an image obtained from a camera of a transmitting device may be provided to a display of a transmitting device. A user may change a location and/or an orientation of a transmitting device until a target device assigned to a receiving device is located in a location within an image obtained. Such a process may use interactive video feedback. After a suitable alignment is made using a camera of a transmitting device, a signal is sent from a display of a transmitting device to a receiving device. Thus a line of sight may be confirmed prior to attempting to transmit a signal from a sending device to a receiving device.

A target device of a receiving device may be located actively, and a signal provided to a user, such as an audio tone, or a visual indicator. A user may simply visually check that a target device is suitably located.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is an exemplary illustration of locations of devices which may be blocked by an intervening object.

FIG. 2 is a flowchart of a method for confirming a line of sight.

FIG. 3 is an exemplary user interface for confirmation of a line of sight between a sending and a receiving device.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter-indicated.

An apparatus is provided which comprises a sending device to emit optical radiation, which may be received by a detector of a receiving device. A sending device may be any device which can control a display which emits and/or modulates optical energy, and which includes an imaging device such as a camera which is located such that it may be pointed in approximately the same direction as a normal to the viewing side of the display that is used to signal a receiving device. A receiving device may be any device which includes a suitable detector such as a camera which can detect optical energy and determine its modulation. A receiving device may include a target device. A target device may be any suitable device which can be detected using a camera of a sending device. A target device may be an active device, such as an LED or other emitter, which may provide a signal which may be used to locate a receiving device. A target device may be a passive device, such as a printed symbol or emblem. Such a target device may allow a user to easily visually recognize a receiving device. A target device may include a reflective surface which makes a display device which is on the opposite surface of a receiving device from a camera of the receiving device visible in an area which can be observed by a camera of a receiving device.

A sending device may be activated to send a signal at any time. A sending device may activate a camera of a sending device and may provide an image obtained by a camera of a sending device to a display which is pointed in the same direction as a display of a sending device, which may be visible to a user of the sending device. A user may be prompted to place the target device within a designated area of an image. A user may activate sending of an optical signal using a control of a sending device. In an embodiment, if a sending device is not detected during an initial attempt, a live view from a camera on the same side of the sending device as a display may be activated and may present video information obtained by the camera on the display.

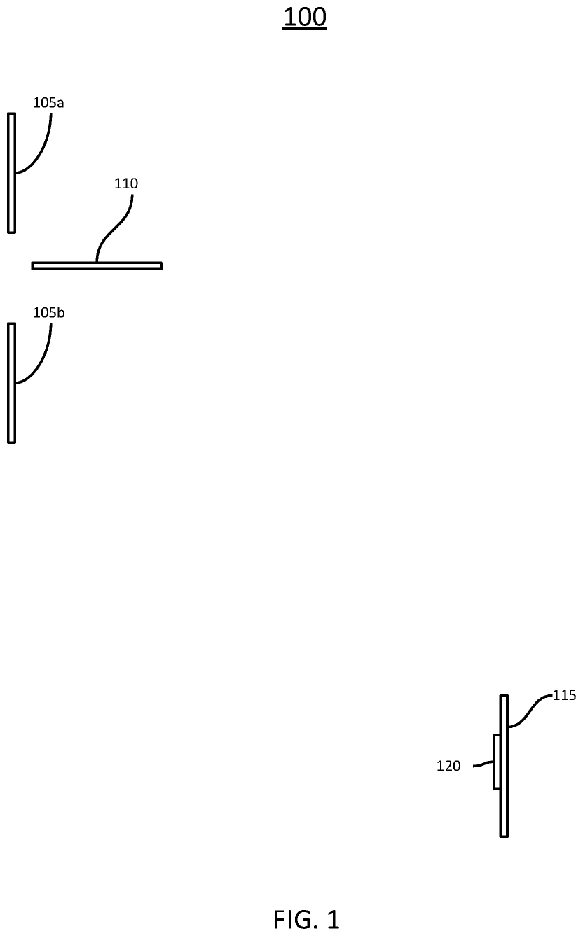

As illustrated in FIG. 1, an exemplary system 100 is illustrated. The system 100 may comprise sending devices, 105a, 105b, a blocking object 110, a receiving device 115, and a target device 120.

A two dimensional drawing is used for purposes of illustration, but one of skill in the art will readily recognize that a three dimensional system would be the normal case. A detecting device such as the detecting device 115 (FIG. 1), may be located in a fixed position, and may comprise a wide-angle lens, such as a fish-eye lens, which may allow a wide viewing angle from a close distance. A ‘fisheye’ lens may have a viewing angle in excess of 180 degrees. As can be readily appreciated from FIG. 1, the sending device 105b has a clear line of sight to the receiving device 115 and can easily find the target device 120. Similarly, a line of sight from the sending device 105a to the receiving device 115, is obstructed by the blocking object 110. The blocking object 110 may be any object which is opaque to optical radiation in a target frequency range emitted by a sending device and detectable by a receiving device. By moving the sending device 105a to a different location, the line of sight may be restored. However, this can most readily be achieved if a camera of the sending device 105a is oriented in the same direction as a normal to the viewing side of the display of the sending device 105a which is to be used to communicate with the receiving device 115. It should be noted that a plurality of receiving devices might be provided which might reduce a probability that a line of sight is obstructed. In a typical system, a detecting device might be located overhead of a restaurant floor and aimed downward so as to obtain a ‘bird's eye’ perspective of a layout of tables. This may cause more objects, such as persons, clothing, and objects on a table, etc., to be more likely to be in a blocking position such as the blocking object 110 (FIG. 1).

The target device 120 may be a passive device such as a printed image. The target device 120 may be an active device such as an LED or other light modulator. The target device 120 may be a reflector which is positioned so as to make a signal emitted by a display of the receiving device which is located on the opposite side from a camera of the receiving device visible from the camera. The target device 120 may be a display device which is located on the same side of a receiving device as a camera of the receiving device. The target device 120 may be illuminated at a frequency which is invisible to the normal human visual system (i.e., a flashing rate greater than fifty frames per second) which may allow a target device to be more easily differentiated from background objects. A target device might be illuminated by for example a display of the receiving device and/or an LED flash device of a receiving device.

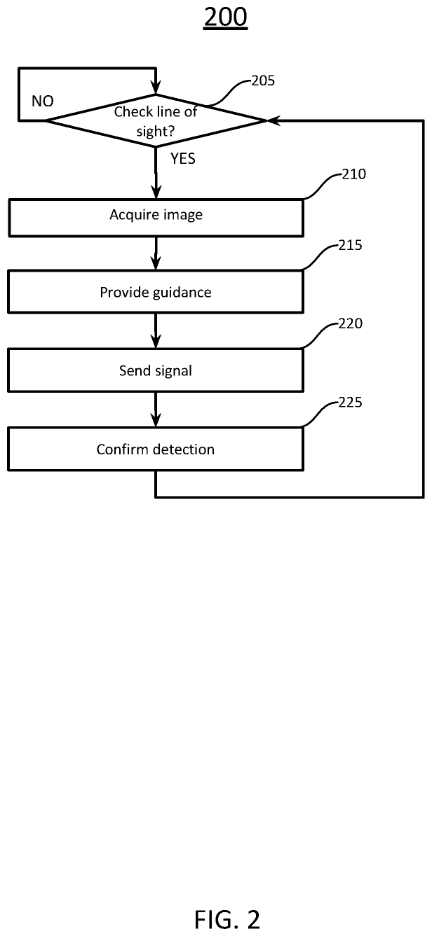

As illustrated in FIG. 2, a process for determining whether a line of sight is available is provided. The process 200 may be implemented by a device such as the sending device 105a (FIG. 1), with or without assistance from a user of the sending device 105a.

In operation 205 a determination is made as to whether a line of sight is to be checked. If in operation 205 it is determined that a line of sight is not to be checked, control remains at operation 205 and process 200 continues. If in operation 205 it is determined that a line of sight is to be checked, control is passed to operation 210 and process 200 continues.

The determination in operation 200 may be made in various ways. For example, if a sending device attempts to communicate with a receiving device and is unable to succeed, it may be determined that a line of sight is to be checked. An input from a user, such as an input control of a sending device may be used to determine whether a line of sight is to be checked. A sending device may attempt to locate a target device of a receiving device and a result of such a process may be used to determine whether a line of sight is to be checked. Any suitable criteria may be used to determine whether a line of sight is to be checked.

In operation 210 an image is acquired. An image is acquired using a camera which is pointed in a direction aligned with a normal to a viewing side of a display which is used to send an optical signal. An image may be acquired as a single image. In an embodiment, a continuous series of images (i.e., video) may be acquired. Any number of images may be acquired. Control is passed to operation 215 and process 200 continues.

In operation 215, guidance is provided. Guidance may be provided in various ways. For example, a display of a sending device may be updated with an image acquired in operation 210, which may allow a user to change a location and/or an orientation of a sending device. A sending device may automatically locate a target. For example, a pattern associated with a target device might be recognized in an automated fashion such as optical pattern matching. In an embodiment, an optical semaphore transmitted by a display of a receiving device may be analyzed to locate a receiving device which may be used to provide guidance. A result of an automated process might be used to determine whether a change of location is needed. A number of target devices may be provided which may be used to determine a relative location of a sending device versus a receiving device. Control is passed to operation 220 and process 200 continues.

In operation 220 a signal is sent. In an embodiment, a signal may be sent regardless. A signal may be transmitted at any time. A signal may not be transmitted if a guidance criterion is not satisfied. A signal may be sent based on a confirmed location of a target device and/or a receiving device. Control is passed to operation 225 and process 200 continues.

In operation 225 detection is confirmed. If a signal sent in operation 220 is received by a receiving device, detection may be confirmed. In an embodiment detection may always be confirmed. Control is passed to operation 205 and process 200 continues.

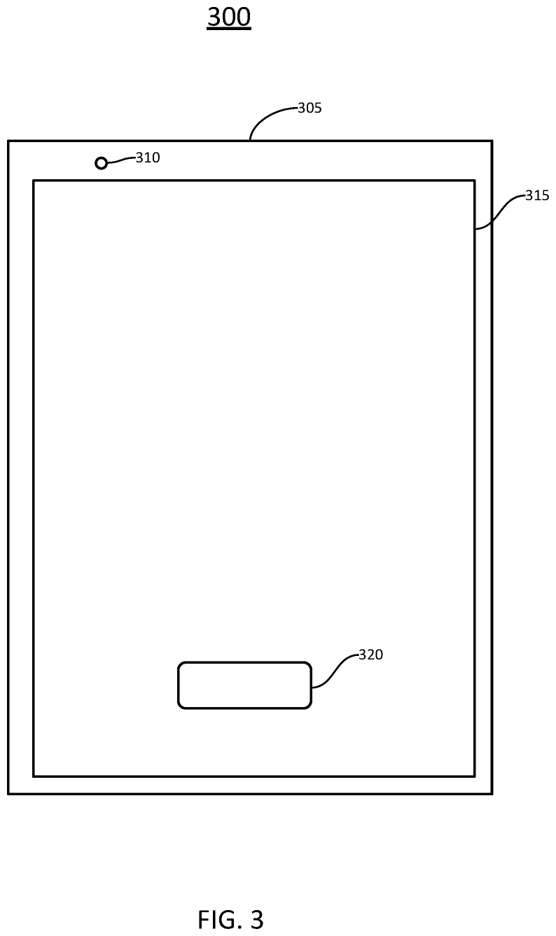

An exemplary user interface (UI) 300 for providing guidance to check a line of sight is illustrated in FIG. 3. The UI 300 may be provided using a display 315 of a sending device 305 such as the sending device 105a (FIG. 1). The sending device 305 may comprise a camera device 310, and a completion control 320. An image obtained by the camera device 310 may be provided by the display 315. If a target device is observed by a user in the display 315, a user may activate the completion control 320 to indicate that a line of sight is available. Alternately, the completion control may be omitted, and a user may be provided with visual indicators based on automated processing of an image obtained by the camera device 310, which may prompt a user to maintain a current location and/or orientation while a signal is transmitted.

A method of optical communication is described. A system wherein a display device of a sending device may be used to send an optical signal to a camera or other detector of a receiving device is provided. A receiving device may comprise a target device which may be used to confirm that a sending device has a clear line of sight to a receiving device. An image obtained from a camera which is pointed in a direction normal to the viewing side of the surface of a display device which is used to send an optical signal from a sending device may be used to determine whether a line of sight is available.

While the system has been described in the context of optical communication between two cell phone devices, the techniques and methods described herein might be applied in other instances. For example, if the sending and receiving devices were located at a large distance from each other (e.g., thirty meters) and the sending device were placed in a pan/tilt apparatus, an optical link could be established based on automated feedback to a controller of the pan/tilt unit based on processing of images, which might include a target device, received by the sending device. Similarly the system and methods might find application in enabling tracking of devices which were subject to unpredictable and/or random motion between a sending device and a receiving device such as communication between two moving vehicles, boats, and/or aircraft.

Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method for optical communication comprising:
obtaining an image from a camera device which is pointing in a direction which is aligned with a normal to a viewing surface of a display of a sending device;
providing a target device attached to a receiving device; and
determining whether a line of sight exists between the sending device and the receiving device based on the image.

2. The method of claim 1 further comprising:
providing the image to a user using the display; and
determining whether the line of sight exists based on an input from the user.

3. The method of claim 1 further comprising:
determining whether the line of sight exists based on pattern matching of the image with a pattern assigned to the target device.

4. The method of claim 1 further comprising:
obtaining the image when it is determined that the sending device is not detected by the receiving device.

5. The method of claim 1 wherein the target device comprises a passive optical pattern.

6. The method of claim 1 wherein the target device comprises a temporal optical pattern uniquely assigned to the target device.

7. The method of claim 1 wherein the target device comprises a light source which illuminates the target device in a temporal pattern.

8. An apparatus for optical communication comprising:
a sending device comprising a camera and a display wherein the camera is pointed in a direction normal to a viewing surface of the display and an input for determining whether a target device is detected; and
a receiving device comprising a detector and the target device.

9. The apparatus of claim 8 wherein the target device comprises a passive optical pattern.

10. The apparatus of claim 8 wherein the target device comprises an active optical device which emits an optical pattern assigned to the target device.

11. The apparatus of claim 8 wherein a user action responsive to an image obtained by the camera provided to the display is the input.

12. The apparatus of claim 8 wherein the target device is illuminated at a temporal rate which is not visible to a human observer.

13. The apparatus of claim 8 wherein the field of view of a detector of the receiving device is wider than a field of view of a camera of the sending device.

14. The apparatus of claim 8 wherein the sending device and the receiving device are wireless devices and the sending device emits an optical signal which is modulated at a frame rate greater than fifty frames per second.

15. The apparatus of claim 8 further comprising:
at least one additional target device which is located at a predetermined location relative to the receiving device.

16. The apparatus of claim 8 wherein a sequence of images which is analyzed based on a temporal illumination frequency which is used to illuminate the target device is the input.

17. The apparatus of claim 8 wherein the target device comprises a reflective surface which is modulated by a display of the receiving device.

18. The apparatus of claim 8 wherein the image is augmented based on temporal processing of a sequence of images and presented to a user via the display of the sending device.

19. A non-transitory computer readable storage medium storing therein a program for causing a computer to execute an operation comprising:
obtaining an image from a camera device which is pointing in a direction which is aligned with a normal to a viewing surface of a display of a sending device;
determining whether a target device associated with a receiving device is present in the image; and
determining whether a line of sight exists between the sending device and the receiving device based on an input.

20. The computer readable storage medium of claim 19 wherein the operation further comprises:
presenting the image using a display of the sending device;
illuminating the target device using a frame rate greater than fifty frames per second;
temporally filtering a sequence of images to determine whether the target device is present in an image;
providing visual guidance to a user based on an additional target device which is located in a predetermined location relative to the receiving device;
obtaining a user input which indicates that the target device is present in the image; and
emitting an optical signal from a display of the sending device.
